(19) United States
(12) Patent Application Publication
(10) Pub. No.: US 2023/0309736 A1
(43) Pub. Date: Oct. 5, 2023

(54) IMPROVED SELF-CLEANING CENTRIFUGAL COFFEE BREWER

(71) Applicant: SPINN HOLDING B.V., Amsterdam (NL)

(72) Inventors: Serge Alfred Johan DE WARRIMONT, Amsterdam (NL); Roderick DE RODE, Amsterdam (NL); Jasper VAN 'T WEL, Bussum (NL); Jasper Pieter DE NIJS, Kota Bogor, Jawa (ID); Vincent WESSELINK, Amsterdam (NL); Daan OOSTVEEN, Haarlem (NL); Huibert HARTELOH, Amsterdam (NL)

(21) Appl. No.: 18/024,683

(22) PCT Filed: Sep. 7, 2020
(86) PCT No.: PCT/EP2020/074939

§ 371 Date: Mar. 3, 2023

(51) Int. Cl. A47J 31/22; A47J 31/42; A47J 31/52; A47J 31/60; A47J 31/46

(52) U.S. Cl. CPC A47J 31/22; A47J 31/42; A47J 31/52; A47J 31/60; A47J 31/46

(57) ABSTRACT

In an aspect, the invention relates to a centrifugal coffee brewing device, the centrifugal coffee brewing device comprising: —a centrifugal brewing unit constructed to brew coffee, the centrifugal brewing unit comprising: o a chamber element comprising a bottom wall and a roof portion, o a cylinder element comprising a filter, —a cylinder element actuator, configured to move the cylinder element upwards and/or downwards, the cylinder element actuator being controllable by at least one cylinder element actuator control signal, —a centrifugal brewing unit motor configured to rotate at least the chamber element of the centrifugal brewing unit around a first axis, —a liquid supply assembly comprising a liquid inlet channel configured to supply liquid into the chamber element, wherein the liquid comprises water and/or a cleaning agent, —a device control system configured for providing: o at least one cylinder element actuator control signal to the cylinder element actuator to control the cylinder element actuator, o at least one motor control signal to the centrifugal brewing unit motor to control the centrifugal brewing unit motor, and o the at least one liquid supply assembly control signal to the liquid supply assembly to control the liquid supply assembly, wherein the device control system is configured to select and execute a predetermined sequence of the above signals, wherein the centrifugal brewing unit is substantially free of unbrewed ground coffee during the predetermined sequence.

### FIELD OF THE INVENTION

The present invention relates to a centrifugal coffee brewer and the cleaning of a centrifugal coffee brewer. Centrifugal coffee brewers are known.

### BACKGROUND OF THE INVENTION

WO2019031964A8 (herein: D1) discloses a centrifugal coffee brewing device, comprising a spinning assembly that is used as a brewing chamber. This spinning assembly comprises a chamber element with a roof and a lower end and is closed off on its sides by a cylindrical filter element. In operation, a coffee bed is formed over the height of this filter element and is wettened by hot water, extracting the coffee beverage. Upon completion of the beverage, the filter element is removed and the coffee bed is expelled due to the centrifugal forces acting on the coffee bed as a result of the rotation. It was found that this device has a number of drawbacks.

A drawback of the device of D1 is that the device is not very easy to clean. Ground coffee and water can reach various parts of the device and contaminate said parts. Ground coffee and scale can build-up through-out the inner workings of the device.

Another drawback of the device of D1 is that, because the brewing process of coffee generally necessitates the passage of hot water through ground coffee, airborne water particles in the form of condensation or steam wetten the inside of the device. Ground coffee residue can accumulate on these wetted surfaces and unhygienic moulds may grow as a result thereof.

Another drawback associated with D1 is that the different parts that are exposed to this wet atmosphere and to ground coffee are not easily taken out of the machine for cleaning or replacement purposes.

It was also recognized that the device of D1 does not allow the brewing of a cup of coffee other than from the beans that are in the hopper, thus limiting the choice of different coffee flavours of a user.

US2018325303A1 discloses a centrifugal coffee brewing device that comprises a self-cleaning brewing assembly. A brewing liquid flows through the same orifice as the ground coffee is supplied through to a brewing chamber. The liquid flows in between brewing cycles and cleans the surface of the interior wall upon which ground coffee may have adhered. A drawback of this device is that only the surface of the interior walls can be cleaned.

WO2013064709A1 discloses a device for the brewing of beverages wherein a special dispensing system dispenses a soluble product to be mixed with water. The device is also suited to be cleaned by removing a hopper with a transport worm system wherein the soluble product is held in the hopper and dispensed by the transport screw. A drawback of this device is that the machine has to be disassembled up to some extend before being able to clean the various components.

WO2008113998A1 relates to an ingredient dispensing apparatus comprising two hoppers and two interconnected transport screws. The rotation of the transport screws in a first direction causes the dispensing of a first ingredient from the first hopper, while the rotation of the transport screws in a second direction causes the dispensing of a second ingredient from the second hopper. Although the invention enables a user to choose between different flavours, a drawback is that two hoppers and two transport screws are needed.

### OBJECTS OF THE INVENTION

It is an object of the invention to provide a device which suffers less from at least one of the drawbacks mentioned above.

### SUMMARY OF THE INVENTION

The centrifugal coffee brewing device are disclosed herein provides several independent improvements over the prior art that may lessen the abovementioned drawbacks.

In a first aspect, the invention relates to a centrifugal coffee brewing device comprising:
a centrifugal brewing unit constructed to brew coffee, the centrifugal brewing unit comprising:
   a chamber element comprising a bottom wall and a roof portion,
   a cylinder element comprising a filter,
a grinder constructed to grind coffee beans,
a supply tube extending between the grinder and the centrifugal brewing unit,
a cylinder element actuator, configured to move the cylinder element upwards and/or downwards, the cylinder element actuator being controllable by at least one cylinder element actuator control signal,
a centrifugal brewing unit motor configured to rotate at least the chamber element of the centrifugal brewing unit around a first axis, the centrifugal brewing unit motor being controllable by at least one motor control signal,
a liquid supply assembly comprising a liquid inlet channel configured to supply liquid into the chamber element, wherein the liquid comprises water and/or a cleaning agent, the liquid supply assembly being controllable by at least one liquid supply assembly control signal,
a device control system configured for providing:
   at least one cylinder element actuator control signal to the cylinder element actuator to control the cylinder element actuator to provide an upwards and/or downwards movement of the cylinder element,
   at least one motor control signal to the centrifugal brewing unit motor to control the centrifugal brewing unit motor to provide a specific rotational speed of at least the chamber element, and a specific rotation direction of at least the chamber element, and
   the at least one liquid supply assembly control signal to the liquid supply assembly to control the liquid supply assembly to provide at least a specific volume of liquid,
   wherein the device control system is configured to select and execute a predetermined sequence of the at least one cylinder element actuator control signal, the at least one motor control signal to the centrifugal brewing unit motor, and the at least one liquid supply assembly control signal to the liquid supply assembly, wherein the selection and execution of the predetermined sequence causes the cylinder element to move upwards and/or downwards, causes at least the chamber element to rotate at a specific speed and in a specific direction, and causes the liquid supply assembly to provide a specific volume of liquid, to clean the centrifugal coffee brewing device,
   wherein the centrifugal brewing unit is substantially free of unbrewed ground coffee during the predetermined sequence.

A centrifugal coffee brewing device as described above is capable of cleaning itself, for example, prior to or after brewing coffee. By providing control signals, the device control system can cause the cleaning of various components. This increases the hygiene of the device and decreases bad influences on the taste of the coffee.

While cleaning the centrifugal coffee brewing device, substantially all the ground coffee used in a brewing cycle has been ejected prior to cleaning, i.e. no ground coffee is supplied to the centrifugal brewing unit between the brewing of coffee and the cleaning sequence thereafter.

In an embodiment, the device control system is configured to drive the centrifugal brewing unit motor and the liquid supply assembly to vary over time at least one of:
the rate of flow of liquid,
the volume of liquid,
the rotational speed of at least the chamber element.

In an embodiment, the device control system is configured to select and execute a combination of the cylinder element control signal, the motor control signal, and the liquid supply assembly control signal, to cause the centrifugal coffee brewing device to:
a) operate the cylinder element actuator to move the cylinder element to a lower position,
b) successively operate the liquid supply assembly to provide a predetermined volume of liquid to the centrifugal brewing unit,
c) successively or simultaneously operate the centrifugal brewing unit motor to provide a rotational speed of the centrifugal brewing unit, wherein the rotational speed is varied over time.

Such a selection of the various signals causes the liquid to flow through the inner workings of the centrifugal brewing unit. By flowing through the various nooks and crannies of the device, the liquid can clean the device without taking it apart. It will be understood that such a user friendly cleaning process means that it will be executed more often, thus resulting in a cleaner device.

Below, various specific cleaning sequences will be elaborated upon to further illustrate the capabilities of a centrifugal coffee brewing device according to the invention.

In an embodiment, the device control system is configured to select and execute a motor control signal that causes the centrifugal brewing unit to eject the volume of liquid. In particular the selection and execution of the motor control signal causes the flushing and pre-heating the flow path of the coffee.

By executing such a motor control signal with a heated amount of liquid inside the centrifugal brewing unit, the flow path of the coffee is rinsed and heated. When this is done before an amount of coffee is brewed, the coffee flowing out of the device will be hot (as little heat has been lost to the pre-heated flow path) and the coffee beverage will not be contaminated with residue from, for example, a prior brewing cycle (as the flow path has been rinsed).

In an embodiment, the device control system is configured to select and execute a motor control signal that causes the centrifugal brewing unit to accelerate and decelerate one or more times before ejecting the volume of liquid.

Such a motor control signal can be used to clean the centrifugal brewing unit and to pre-heat it in a similar manner as described above for the flow path. It can also be used to clean the centrifugal brewing unit more thoroughly.

In an embodiment, the device control system is configured to select and execute a motor control signal that causes a first predetermined volume of liquid to clean the chamber element and a first side of the filter and a second side of the filter. The first side may face towards the chamber element, and the second side may face away from the chamber element.

The first predetermined volume of liquid may be chosen so that when executed, the motor control signal causes the liquid to flow around in the chamber element and on both sides of the filter. This is particularly useful to clean the second side of the filter which would otherwise be particularly difficult to reach.

In an embodiment, a first predetermined volume of liquid is at least one third of an inner volume of the centrifugal brewing unit.

In an embodiment, the supply tube extends into the chamber element. When using the first predetermined volume of liquid, the supply tube may then also be cleaned.

In a further embodiment, the device control system is configured to select and execute a motor control signal that causes the operation of the centrifugal brewing unit motor a predetermined amount of time after the device control system causes the operation of the liquid supply assembly.

In doing so, the liquid is allowed to settle in the chamber element. Additionally, in the case where the liquid comprises a cleaning agent, e.g. a descaling agent, the cleaning agent can have the time to work on the different components before being flushed out.

In an embodiment, the centrifugal coffee brewing device further comprises a cylinder element cavity configured to accommodate the cylinder element in an upper position. A second predetermined volume of liquid can be injected that is larger than an inner volume of the centrifugal brewing unit and that is smaller than the volume of the centrifugal brewing unit and the cylinder element cavity together.

The device control system can be configured to select and execute a motor control signal that causes the second predetermined volume of liquid to flow back and forth through the cylinder element. In particular the flow path may extend between a lower side of the roof portion and an upper side of the roof portion and through the cylinder element. Herein the flow cleans at least the upper side of the roof portion and at least a side of the cylinder element directly facing the first axis and the upper side of the roof portion.

Using this second predetermined volume of liquid, the device may be very thoroughly cleaned. Such a thorough cycle may be executed less often than the previously mentioned sequences, especially if the previous cycles are executed on a regular basis.

In an embodiment, wherein the centrifugal coffee brewing device further comprises a spout and a spout actuator, the spout actuator is configured to move the spout between at least a dispensing state and a closed state. The spout actuator can be controllable by at least one spout actuator control signal to control the spout actuator to provide a movement between at least the dispensing state and the closed state. The device control system is then further configured to select and execute a spout actuator control signal to cause the operation of the spout actuator to move the spout to the closed state at least prior to the operation of the liquid supply assembly and to select and execute a spout actuator control signal to cause the operation of the spout actuator to move the spout to the dispensing state prior to or after the ejecting of the volume of liquid.

In an embodiment, the spout actuator is also configured to move the spout to a drip state. In such a state, the spout is configured to divert a flow from a gutter element into a drip receptacle instead of letting it flow out of the device. For example, this may prevent the spout from dripping outside of the device after a serving of coffee has been brewed.

In an embodiment of the invention, further comprising a coffee gutter extending around the centrifugal brewing unit and towards the spout, the device control system is configured to select and execute a spout actuator control signal to move the spout to the dispensing state after the at least part of the ejected volume of liquid is in the gutter.

In doing so, the liquid may be located in the gutter for a certain amount of time. This can be used to, for example, soak off dirt that has accumulated in the gutter or to, in the case where the liquid comprises a descaling agent, descale the gutter. This way, a component that would be very difficult to access can be thoroughly cleaned, further increasing the hygiene of the centrifugal coffee brewing device.

In a further embodiment, the liquid supply assembly further comprises a direct water injection nozzle and the device control system is configured to select and execute a combination of the cylinder element control signal, the motor control signal, and the liquid supply assembly control signal, to cause the centrifugal coffee brewing device to successively:
a) operate the cylinder element actuator to move the cylinder element to an upper position,
b) operate the liquid supply assembly to provide a third predetermined volume of liquid to the centrifugal brewing unit,
c) operate the centrifugal brewing unit motor to provide a rotational speed of at least the chamber element, wherein the rotational speed is varied over time.
d) alternate the operations of b) and c) a predetermined number of times,
e) operate the liquid supply assembly to provide a predetermined rate of flow of liquid through the direct water injection nozzle.

In an embodiment, wherein the bottom wall comprises a partially upward projecting seal, the third predetermined volume of liquid is substantially equal to a volume defined by the bottom wall and the partially upward projecting seal.

By causing the centrifugal coffee brewing device to follow the abovementioned steps, a residue deflection cone that is located around the centrifugal brewing unit may be uniformly wettened: the liquid that is held by the bottom wall is circumferentially ejected towards the residue deflection cone. Subsequently, the residue deflection cone is cleaned by the direct injection of the liquid by the direct water injection nozzle against it.

In an embodiment, the device control system is configured to repeat the selection and execution of at least one of the cylinder element actuator control signal, centrifugal brewing unit motor control signal, liquid supply assembly control signal, spout actuator control.

In an embodiment, the device control system is configured to select and execute the predetermined sequence an amount of time after the centrifugal coffee brewing device has been used to brew coffee. In particular, it is configured to do so after 0-15 minutes, more in particular after 5-10 minutes, even more in particular after 7 minutes.

Such a sequence can be used to clean the centrifugal coffee brewing device after an amount of coffee has been brewed and dispensed. This leaves the centrifugal coffee brewing device clean and ready for the next brewing cycle.

In another independent aspect, the invention relates to a centrifugal coffee brewing device comprising:
a centrifugal brewing unit constructed to brew coffee, the centrifugal brewing unit comprising:
   a chamber element comprising a bottom wall and a roof portion,
   a cylinder element comprising a filter,
a grinder constructed to grind coffee beans,
a supply tube extending between the grinder and the centrifugal brewing unit,
at least one air inlet extending between the exterior of the centrifugal coffee brewing device and the centrifugal brewing unit,
at least one air outlet extending between the centrifugal brewing unit and the exterior of the centrifugal coffee brewing device,
a heater element, configured to at least heat a residue deflection cone, the heater element being controllable by at least one heater element control signal,
centrifugal brewing unit motor configured to rotate at least the chamber element of the centrifugal brewing unit, the centrifugal brewing unit motor being controllable by at least one motor control signal,
a liquid supply assembly comprising a liquid inlet channel configured to supply liquid into the chamber element,
a device control system configured for providing:
   the at least one heater element control signal to the cylinder element to control the heater element to heat at least the residue deflection cone, and
   the at least one motor control signal to the centrifugal brewing unit motor to control the centrifugal brewing unit motor to provide a specific rotational speed of at least the chamber element, and a specific rotation direction of at least the chamber element, and
   wherein the device control system is configured to select and execute a predetermined sequence of the at least one heater element control signal and the at least one motor control signal to the centrifugal brewing unit motor, wherein the selection and execution of the predetermined sequence causes the heater element to heat at least the residue deflection cone and causes at least the chamber element to rotate at a specific speed and in a specific direction, to dry the centrifugal coffee brewing device,
   wherein the centrifugal brewing unit is substantially free of unbrewed ground coffee and the liquid supply assembly does not supply liquid into the chamber element during the predetermined sequence.

A centrifugal coffee brewing device as described above is capable of drying itself, for example, prior to or after brewing coffee. By providing the abovementioned control signals, the device control system can cause the internal drying. Because a coffee brewing device is a device that operates with hot liquids, it is inherently a wet and/or humid device susceptible of moulds. Therefore being able to dry itself is a large advantage for the prevention of moulds and the increase of hygiene, intended coffee taste and overall user experience.

When drying the centrifugal coffee brewing device, substantially all the ground coffee used in a brewing cycle has been ejected, i.e. no ground coffee is supplied to the centrifugal brewing unit between the brewing of coffee and the drying sequence thereafter.

In an embodiment, the device control system is configured to select and execute a combination of the motor control signal and the heater element control signal, to cause the centrifugal coffee brewing device to:
a) operate the heater element to heat at least the residue deflection cone,
b) operate the centrifugal brewing unit motor to provide a rotational speed of the centrifugal brewing unit.

By heating the residue deflection cone, the air that is contact therewith is also heated. Combining this with the centrifugal brewing unit that moves the hot air around, the centrifugal coffee brewing device can be dried.

In an embodiment of the invention, further comprising a cylinder element actuator configured to move the cylinder element upwards and/or downwards, the cylinder element actuator is controllable by at least one cylinder element actuator control signal. By controlling the cylinder element actuator an upwards and/or downwards movement of the cylinder element is provided. The device control system is configured to select and execute a cylinder element actuator control signal. Herein, the device control system is configured to select and execute a cylinder element actuator control signal, to cause the cylinder element to move upwards or downwards prior to the operation of the centrifugal brewing unit motor.

In an embodiment, the device control system is configured to select and execute a cylinder element actuator control signal, to cause the cylinder element to move upwards prior to the operation of the centrifugal brewing unit motor.

In another embodiment, the device control system is configured to select and execute a cylinder element actuator control signal, to cause the cylinder element to move downwards prior to the operation of the centrifugal brewing unit motor.

The choice of the location of the cylinder element determines how the air flows within the centrifugal coffee brewing device. For example, with the cylinder element in the upper position, the air is directed towards a residue tray and a residue tray compartment that may be located below the centrifugal brewing unit. When the cylinder element is in the lower position, the air may, for example, be driven out of the device through the spout. In any case, various openings may function as air outlets and various openings may function as air inlets.

In an independent aspect, the invention relates to a centrifugal coffee brewing device, comprising:
a housing defining a hole,
a centrifugal brewing unit constructed to brew coffee,
a conveyor positioned inside the housing, the conveyor comprising,
   a supply tube extending from a coffee supply to the centrifugal brewing unit,
   a transport screw extending through the supply tube and mounted for rotation,
   a transport screw drive comprising connection means to be connected to the transport screw, the transport screw drive being configured for rotating the transport screw,
wherein the supply tube comprises an end located near the hole defined by the housing and wherein the transport screw is removable through the hole defined by the housing.

Such a coffee brewing device allows the simple placement and replacement of a transport screw for maintenance and cleaning purposes. In doing so, the centrifugal coffee brewing device does not have to be taken apart to take out and clean a component that is exposed to wet air and to ground coffee. This results in a cleaner coffee brewing device and therewith in better coffee.

In an embodiment of the centrifugal coffee brewing device, only the transport screw can be removed through the hole. One way to achieve this, would be to match the hole's inner dimensions with the transport screw's outer dimensions.

In an embodiment, the centrifugal coffee brewing device also comprises a removable cover for the hole. This may improve the aesthetics of the device and may also keep dirt and dust out of the centrifugal coffee brewing device.

In an embodiment, the centrifugal coffee brewing device further comprises a transport screw cap. The transport screw cap comprises means to be fixed in a protection position. In this position, the transport screw cap at least partially covers the transport screws and the transport screw drive. This prevents moving parts being exposed to a user when the cover has been removed, increasing the user safety of the machine.

The transport screw cap may also comprise a hook element, wherein at least a part of the hook element is located behind a part of the transport screw and wherein the hook is configured to engage the transport screw when the transport screw cap is moved away from the protection position. The transport screw cap facilitates the removal of the transport screw.

The transport screw cap may further comprise a removal tab. The removal tab extends away from the transport screw when the transport screw cap is in the protection position. The removal tab increases the ease of removal of the transport screw cap.

In an embodiment, the supply tube is curved and the transport screw is flexible. This way, the transport screw can rotate within the curved supply tube without breaking.

In another embodiment, the supply tube is not curved, but the transport screw is flexible. This increases the ease of removal of the transport screw.

In an embodiment of the centrifugal coffee brewing device, an opening is defined in the cover. Alternatively, the cover only partially covers the hole. Both solutions can be used to create an air channel between the centrifugal brewing unit and the exterior of the housing. This may reduce the formation of unhygienic moulds.

In another independent aspect, the invention relates to a coffee brewing device, comprising:
a grinder,
a hopper defining an inner volume and comprising a hopper filling opening and an hopper exit opening located at a lower extremity of the hopper, the hopper filling opening allowing the hopper to be filled with coffee beans, the hopper exit opening being connected to the grinder allowing coffee beans to exit the hopper and enter the grinder, the hopper filling opening and hopper exit opening forming a first bean supply path to the grinder,
a chute, wherein, when the chute is a located in a chute position in the hopper, the chute extends into the inner volume, and wherein the chute comprises a chute filling opening at a first end and an chute exit opening at a second end,
   wherein the chute is extendable between a retracted state and an extended state, wherein in the extended state the chute exit opening is located closer to the hopper exit opening than it is in the retracted state, wherein the chute creates a second bean supply path to the grinder in the extended state.

The use of a coffee brewing device as described above offers the advantage of being able to use two different bean supply paths. This enables a user to experience different flavours of coffee while not needing to empty the hopper before filling it with a new type of coffee bean; the user can experience the new type of coffee parallel to the coffee present in the hopper via the second bean supply path.

In an embodiment, the chute exit opening is moveable between an upper position in the retracted state and a lower position in the extended state.

In an embodiment, the chute engages the hopper exit opening in the extended state.

In an embodiment, the chute comprises a flexible skirt located at the chute exit opening. Such a flexible skirt permits the chute to be extended even though there might still be coffee beans from the hopper in the way; the chute will still create the second bean supply path, because the skirt will deform around said coffee beans.

In a further embodiment, the chute at least partially obstructs the first bean supply path in the extended state. In doing so, the chute prevents the first bean supply path and the second bean supply path to cross and therewith prevents the mixing of different types of coffee beans.

In a further embodiment of the coffee brewing device the chute comprises a telescopic mechanism. In such an embodiment, at least part of the chute is fixed with respect to the coffee brewing device when the chute is located in the chute position.

In an embodiment, the chute comprises a fixed part being fixed relative to the hopper and a rotational part, wherein the rotational part is rotatable by a user. The fixed part comprises one of a cam or a helical cam track and the rotational part comprises the other. The rotation of the rotational part moves the cam over the helical cam track or the helical cam track over the cam. The cam movement or helical cam track movement moves a lower part comprising the chute exit opening between the upper position and the lower position.

The chute may comprise a first rotational upper part, a fixed part, and a second rotational lower part. Herein, the first rotational upper part comprises at least one vertically oriented slot, the second rotational lower part comprises at least one cam, and the fixed part comprises at least one helical cam track defining at least one hole. The at least one cam protrudes outwardly through the at least one hole defined by the cam track into the at least one vertically oriented slot. The rotation of the first rotational upper part—and the vertically oriented slot—drives the cam of the second rotational lower part over the helical cam track because the wall of the vertically oriented slot abuts against the cam. The rotation of the upper part extends and retracts the chute between the extended state and the retracted state, moving the chute exit opening between the lower position and the upper position.

In an embodiment, the coffee brewing device comprises a protection cover, the protection cover being configured to be located in the inner volume of the hopper and near the grinder, wherein the chute extends through the protection cover.

In an embodiment, the protection cover is also the fixed part of the chute.

In an embodiment, the chute comprises an obstruction between the chute filling opening and the chute exit opening. This obstruction is configured to allow beans to move between the chute filling opening to the chute exit opening and to prevent a user to reach the chute exit opening when the chute is located in the chute position.

If such an obstruction wasn't present, a user could potentially reach the grinder. It will be understood that this is a less than desirable situation.

In a further embodiment, the obstruction is fixed to the lower part and closes the chute filling opening when the chute is in the retracted state.

In a further embodiment, the chute is removable between the chute position and a removed position and comprises fixation means to fix the chute with respect to the hopper in the chute position.

These and other aspects of the invention will be more readily appreciated as the same becomes better understood by reference to the following detailed description and considered in connection with the accompanying drawings in which like reference symbols designate like parts.

### BRIEF DESCRIPTION OF THE FIGURES

FIG. 1. shows a view of the exterior of a centrifugal coffee brewing device.

FIG. 2a-2c show an isometric view and cross-sections of the inner workings of an embodiment of the centrifugal coffee brewing device.

FIGS. 3a and 3b show a cross-section of an embodiment of the invention during a cleaning cycle.

FIGS. 4a and 4b show a cross-section of an embodiment of the invention during a cleaning cycle.

FIGS. 5a and 5b show a cross-section of an embodiment of the invention during another cleaning cycle.

FIGS. 6a and 6b show a cross-section of an embodiment of the invention during another cleaning cycle.

FIGS. 7a and 7b show a cross-section of an embodiment of the invention during a cleaning cycle.

FIGS. 8a and 8b show a cross-section of an embodiment of the invention during another cleaning cycle.

FIGS. 9a and 9b show a cross-section of an embodiment of the invention during a cleaning cycle.

FIGS. 10a and 10b show a cross-section of an embodiment of the invention during a cleaning cycle.

FIGS. 11a and 11b show a cross-section of an embodiment of the invention during another cleaning cycle.

FIG. 12 shows a cross-section of an embodiment of the invention during another cleaning cycle.

FIGS. 13a and 13b show a cross-section of an embodiment of the invention during a drying cycle.

FIGS. 14a and 14b show a cross-section of an embodiment of the invention during another drying cycle.

FIGS. 15a and 15b show an isometric view of an embodiment comprising a removable transport screw.

FIG. 16 shows a cross-section of the centrifugal coffee brewing device comprising a removable transport screw.

FIGS. 17a and 17b show a close-up view of the hole defined by the housing of an embodiment of the invention.

FIGS. 18a and 18b show an embodiment of the transport screw cap standing alone.

FIGS. 19a and 19b show an isometric view of an embodiment of a coffee brewing device comprising a chute.

FIGS. 20a and 20b show a close-up view of the hopper and a chute according to an embodiment of the invention.

FIGS. 21a and 21b show an embodiment of the chute in different positions standing alone.

FIGS. 22a and 22b show a cross-section of an embodiment of the chute in different positions in the coffee brewing device.

FIG. 23 shows an isometric overview of an embodiment of the invention wherein the grinder is visible.

### DETAILED DESCRIPTION OF THE FIGURES

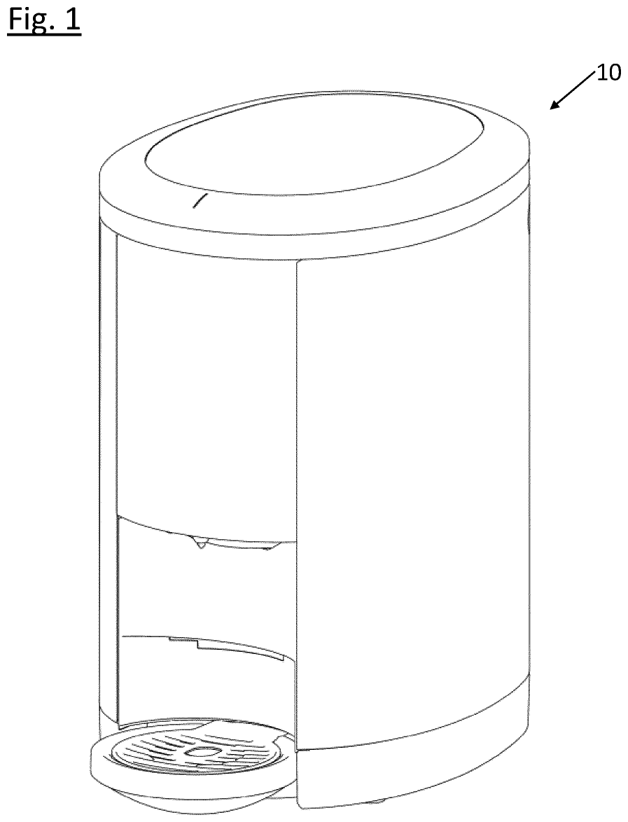

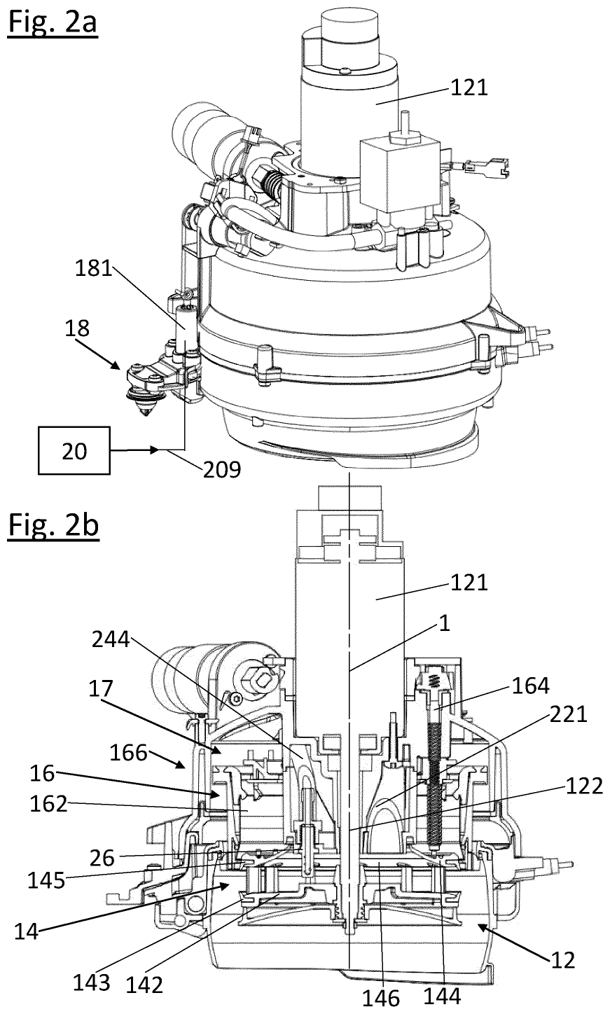

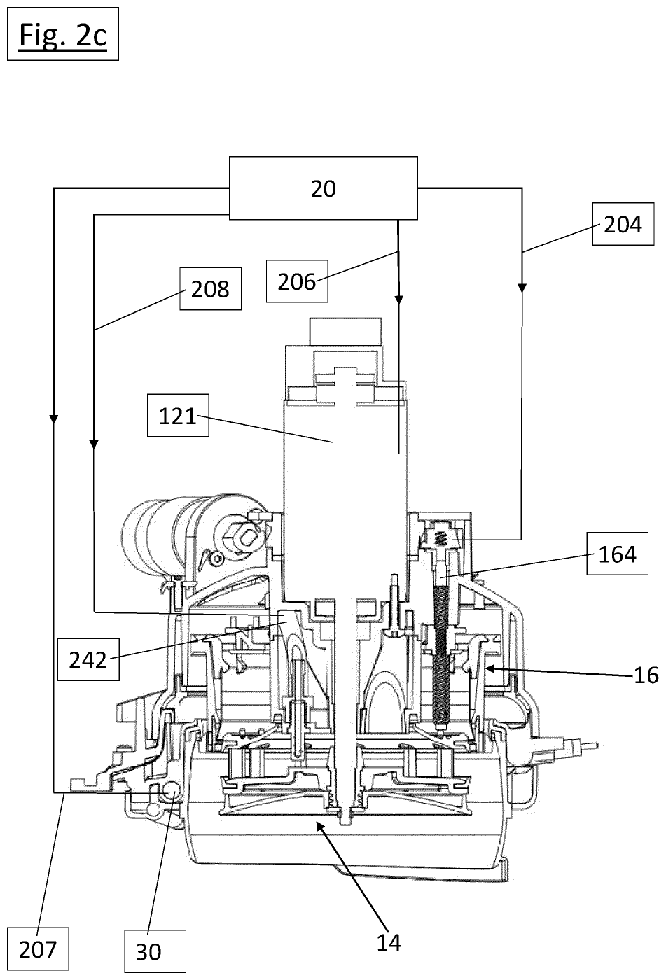

Turning to FIGS. 1, 2a, and 2b, an overview is given of the centrifugal coffee brewing device 10 and its inner workings. FIG. 1 gives an impression of the exterior of the centrifugal coffee brewing device, and FIGS. 2a, and 2b respectively depict an isometric view of the inner workings and a cross-section thereof. Herein the spout 18 is shown together with the spout actuator 181, both will be further elaborated upon.

In FIG. 2b, a centrifugal brewing unit motor 121 is shown that is configured to rotate the chamber element 14 and the cylinder element 16 of the centrifugal brewing unit 12 around a central axis 1. The centrifugal brewing unit motor is connected to the centrifugal brewing unit 12 via a shaft 122 that protrudes through a stationary roof portion 146 of the chamber element 14. In the depicted situation, the cylinder element 16, comprising a filter 162, is shown in an upper position 166 located in a cylinder element cavity 17. The cylinder element 16 has been moved into this position by a cylinder element actuator 164. The chamber element 14 comprises a bottom wall 142, a stationary roof portion 146 and a rotational roof portion 144. The bottom wall 142 and the rotational roof portion 144 are both connected to a respective seal 143, 145. These seal are configured to engage the cylinder element 16 when the cylinder element is located in a lower position 168 (not depicted here).

In order to be able to brew coffee, a liquid supply assembly comprises a liquid inlet channel 244 and a direct water injection nozzle 26. The liquid supply assembly is configured to supply liquid into the chamber element, wherein the liquid can comprise water and/or a cleaning agent.

The centrifugal coffee brewing device 10 also comprises a coffee supply assembly comprising a grinder 22 (not depicted here) and a supply tube 221 in which a transport screw (not depicted here) may be present to supply ground coffee to the chamber element 14.

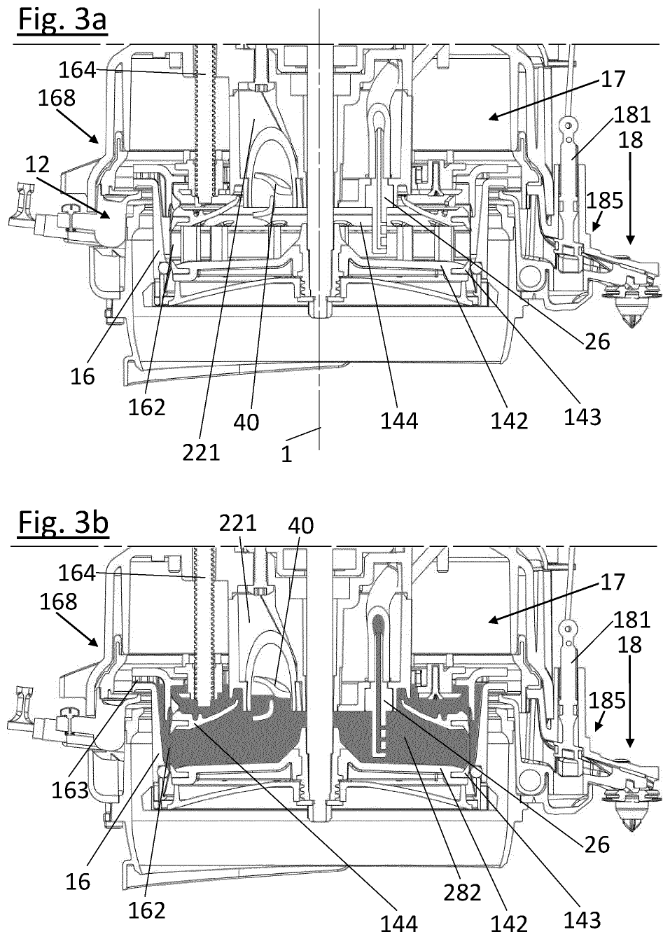

A coffee brewing cycle would be initiated by the grinder 22 producing ground beans that enter the chamber element 14 via the supply tube 221, which on one side is connected to the grinder and on the other to the chamber element 14. In turn, the liquid supply assembly 242 would provide water via the liquid inlet channel 244 and the direct water injection nozzle 26 that is connected to the stationary roof part 146 into the chamber element 14. Also, the chamber element 14 would be driven to rotate by the centrifugal brewing unit motor 121 that drives the rotation of the centrifugal brewing unit 12 via the shaft 122. The cylinder element 16 comprising the filter 162 rotates together with the chamber element 14. When the cylinder element is in the lower position 168, the seals 143, 145 engage the cylinder element 16 in order not to let a liquid flow substantially out of the chamber other than through the exit opening 163 (depicted in FIG. 3b) of the cylinder element 16. Subsequently, coffee is ejected through the exit opening 163 of the rotating cylinder element 16 and into the stationary gutter 80 where it is diverted to the spout 18 and dispensed to the user.

After having brewed coffee, the cylinder element 16 is moved into the upper position 166 by the cylinder element actuator 164 and the used coffee grounds are ejected from the chamber element 14 due to the centrifugal force of the rotation. They are redirected in a downwards direction by the residue deflection cone 82 and collected in a residue tray (not depicted).

In FIGS. 2a and 2c, a device control system 20 is shown. The device control system is configured for providing:
at least one cylinder element actuator control signal 204 to the cylinder element actuator 164 to control the cylinder element actuator to provide an upwards and/or downwards movement of the cylinder element 16,
at least one motor control signal 206 to the centrifugal brewing unit motor 121 to control the centrifugal brewing unit motor to provide a specific rotational speed of at least the chamber element 14, and a specific rotation direction of at least the chamber element 14, and
the at least one liquid supply assembly control signal 208 to the liquid supply assembly 242 to control the liquid supply assembly 242 to provide at least a specific volume of liquid,
at least one spout actuator control signal 209 to the spout actuator 181 to control the spout actuator 181 to provide a movement of the spout between at least a dispensing and a closed state,
at least one heater element control signal 207 to the heater element 30 to control the heater element 30.

Herein, the device control system 20 is configured to select and execute a predetermined sequence of the abovementioned signals 204, 206, 207, 208, 209. The selection and execution of such a sequence can cause the cylinder element 16 to move upwards and/or downwards, can cause at least the chamber element 14 to rotate at a specific speed and in a specific direction, can cause the liquid supply assembly 242 to provide a specific volume of liquid, can cause the spout 18 to be moved into a dispensing state and a closed state, and can cause the heater element 30 to heat.

Such a sequence can be used to clean and to dry the centrifugal coffee brewing device 10 when the centrifugal coffee brewing unit 12 is substantially free of unbrewed ground coffee during the predetermined sequence. Non-limiting examples of specific sequence are elaborated upon below.

Turning to FIGS. 3a and 3b, the start of a cleaning sequence is shown. Herein, the device control system has selected and executed a combination of the cylinder element control signal, the motor control signal, and the liquid supply assembly control signal. This has caused the operation of the cylinder element actuator 164 to move the cylinder element 16 to the lower position 168 in FIG. 3a. Subsequently, in FIG. 3b, the operation of the liquid supply assembly 242 has provided the chamber element 14 with a second predetermined volume of liquid 282. A predetermined amount of time after the device control system 20 causes the operation of the liquid supply assembly 242, the operation of the centrifugal brewing unit motor provides a rotational speed of the centrifugal brewing unit 12, wherein the centrifugal brewing unit rotates around the central axis 1. Herein, the rotational speed is varied over time.

In the depicted sequence, the predetermined volume of liquid 282 is larger than an inner volume of the centrifugal brewing unit 12; the rotational roof portion 144 of the chamber element 14 is submerged and an extremity of the supply tube 221 and the transport screw 40 are also submerged. In this embodiment, the supply tube 221 is shown to extend into the chamber element 14. It can be seen that the predetermined volume of liquid 282 is smaller than the volume of the centrifugal brewing unit 12 and the cylinder element cavity 17 together.

Through the selection and execution of a motor control signal, the liquid of the predetermined volume of liquid 282 may flow back and forth through the cylinder element, in particular the flow path may extend between a lower side of the roof portion and an upper side of the roof portion and through the cylinder element. The flow then cleans at least the upper side of the roof portion and at least a side of the cylinder element directly facing the first axis and the upper side of the roof portion.

By selecting and executing a motor control signal that causes the centrifugal brewing unit 12 to accelerate and decelerate at least once, the inner workings of the centrifugal coffee brewing device 10 are cleaned. In particular, difficult to reach areas such as the space between the filter 162 and the cylinder element 16 and the top of the rotational roof portion 144 are cleaned. This is a large benefit because this wouldn't be possible without taking the entire device apart.

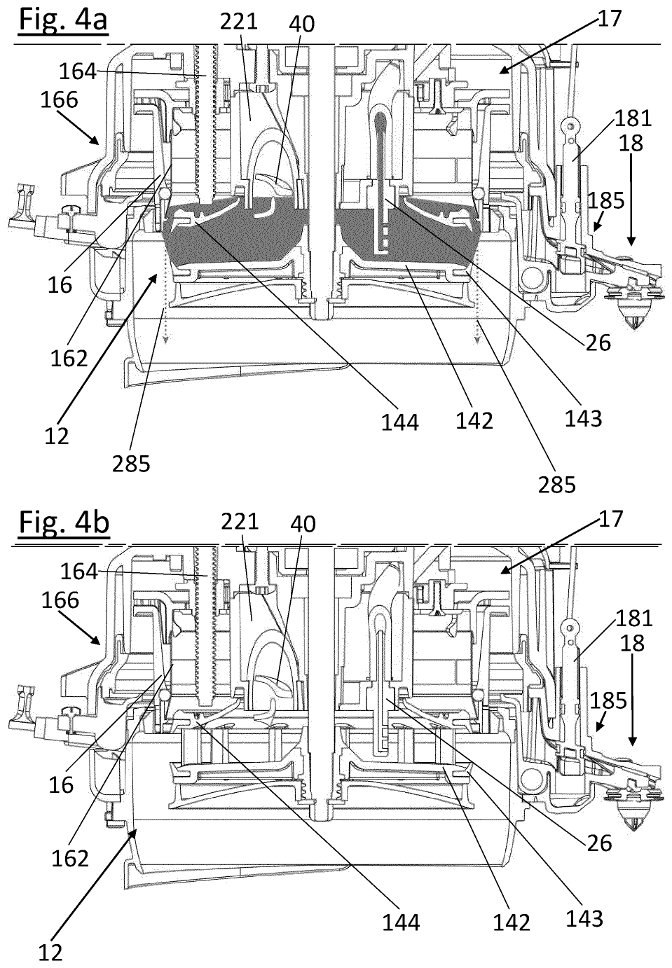

Turning to FIG. 4a, the device control system 20 has selected and executed a cylinder element 164 actuator signal that has caused the upwards movement of the cylinder element 16 into the upper position 166. Subsequently, the predetermined volume of water 282 is ejected and flows out of the chamber element 14 into a residue tray (not depicted) located below the chamber element 14. The flow is depicted by arrows 285. FIG. 4b shows the centrifugal coffee brewing device after it has been cleaned.

The sequence described above and depicted in FIGS. 3a, 3b, 4a, and 4b can be executed one or more times.

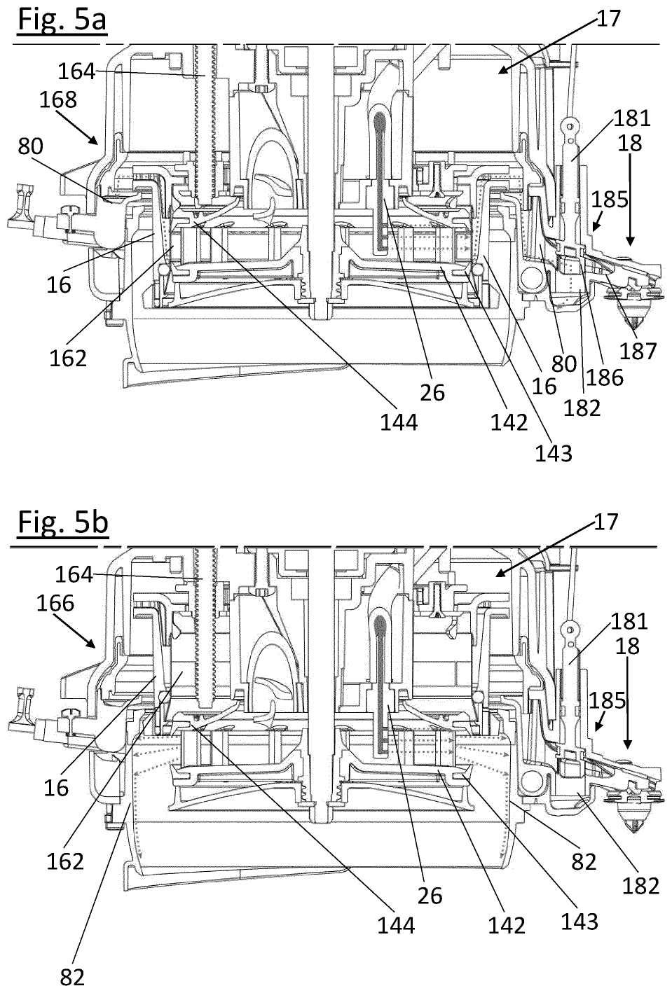

FIGS. 5a and 5b show two sequences that may be chosen following the previously described sequence, but can also be chosen separately. Herein, the dashed grey arrows depict the flow path of the liquid.

In FIG. 5a, the operation of the cylinder element actuator 164 has caused the cylinder element 16 to move downwards into the lower position 168. Subsequently, the centrifugal brewing unit motor is rotated to create a centrifugal force on the liquid that is injected in to the chamber element 14 by the direct water injection nozzle 26. The liquid passes through the filter 162 and is directed towards the spout 18 by the cylinder element 16 and the gutter 80. In the depicted embodiment, the spout actuator 181 has moved the spout in a drip state 185. Herein, the liquid arriving at the spout 18 is directed into a drip channel 182 by a spout guide element 186 instead of through the spout exit channel 187. The drip channel 182 leads to a drip tray (not shown) that functions as a collecting container for liquid passing through the drip channel 182.

The volume of liquid used in the described sequence may be heated so that the flow path of coffee that is to be brewed is pre-heated. Such a sequence may then be execute prior to the brewing of coffee.

In FIG. 5b, the device control system 20 has caused the cylinder element 16 to move upwards into the upper position 166. Subsequently, the centrifugal brewing unit motor is rotated to create a centrifugal force on the liquid that is injected in to the chamber element 14 by the direct water injection nozzle 26. The liquid is directly sprayed on a residue deflection cone 82 in order to clean the residue deflection cone.

Both sequences depicted in FIGS. 5a and 5b can be used after having brewed coffee to clean the centrifugal coffee brewing device in between brewing sequences. In particular this may be done 0-15 minutes after brewing coffee, more in particular after 5-10 minutes, even more in particular after 7 minutes.

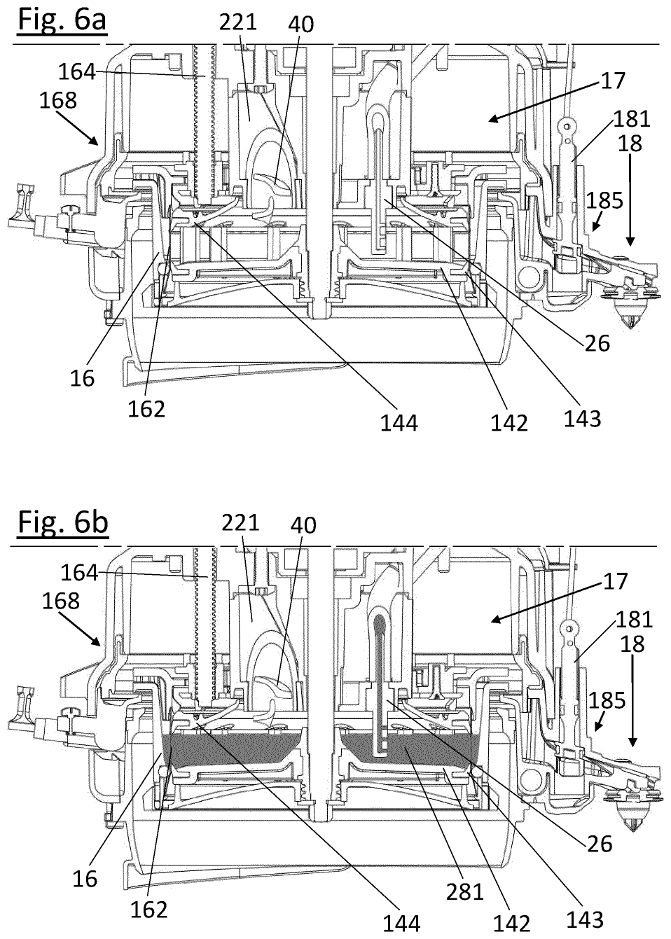

Turning to FIGS. 6a and 6b, the start of another cleaning sequence is shown. Herein, the device control system has selected and executed a combination of the cylinder element control signal, the motor control signal, and the liquid supply assembly control signal. This has caused the operation of the cylinder element actuator 164 to move the cylinder element 16 to the lower position 168 in FIG. 4a. Subsequently, in FIG. 4b, the operation of the liquid supply assembly 242 has provided the chamber element 14 with a first predetermined volume of liquid 281. A predetermined amount of time after the device control system 20 causes the operation of the liquid supply assembly 242, the operation of the centrifugal brewing unit motor provides a rotational speed of the centrifugal brewing unit 12. Herein, the rotational speed is varied over time.

The depicted sequence is similar to the sequence depicted in FIGS. 3a and 3b. However, the first predetermined volume 281 is smaller than the second predetermined volume 282. The first predetermined volume of liquid 281 is at least one third of the inner volume of the centrifugal brewing unit 12.

Through the selection and execution of a motor control signal, the liquid of the predetermined volume of liquid 281 may flow back and forth through the cylinder element. The sequence causes the first predetermined volume of liquid 281 to flow inside the chamber element 14 and along a first side of the filter 162 and along a second side of the filter 162. The first side faces towards the chamber element, and the second side faces away from the chamber element.

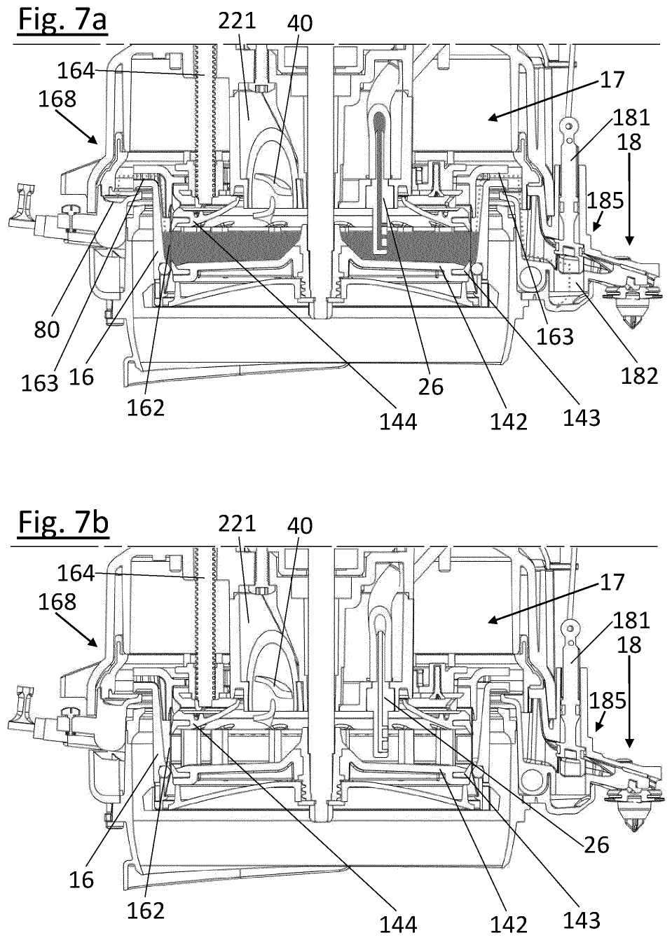

The device control system 20 may select and execute a sequence as mentioned above one or more times. Subsequently, a centrifugal brewing unit motor control signal 206 may be chosen that causes the centrifugal brewing unit to rotate more rapidly, ejecting the predetermined volume of liquid 281 through the filter 162 and via the cylinder element 16 into the gutter 80. This is depicted in FIG. 7a where the flow path of the liquid is shown by the dashed grey arrows from the chamber element 14 via the exit opening 163 of the rotating cylinder element 16. Here, it can also be seen that the spout actuator 181 has moved the spout into the drip state 185 where the liquid flows through the drip channel 182 into the drip tray (not shown). FIG. 7b shows the centrifugal coffee brewing device after it has been cleaned.

Such a sequence can be useful for the regular cleaning of the centrifugal coffee brewing device 10, while the use of the second predetermined volume of liquid 282 may be useful for an even more thorough cleaning that can be executed after a longer period of time.

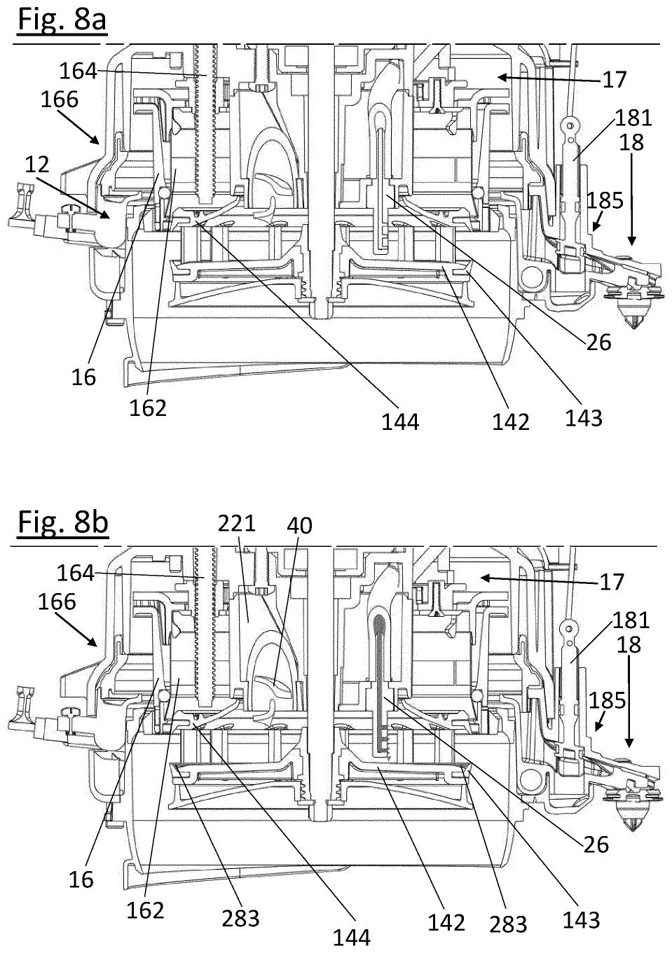

In FIGS. 8a and 8b, the start of another cleaning sequence is shown. In FIG. 8a, the device control system 20 has caused the upwards movement of the cylinder element 16 moving it into the upper position 166 inside the cylinder element cavity 17.

Turning to FIG. 8b, the device control system 20 has operated the liquid supply assembly 242 to inject a third predetermined volume of liquid 283 via the direct water injection nozzle 26 into the chamber element 14. The third predetermined volume of liquid 283 is substantially equal to a volume defined by the bottom wall and the partially upward projecting seal 143.

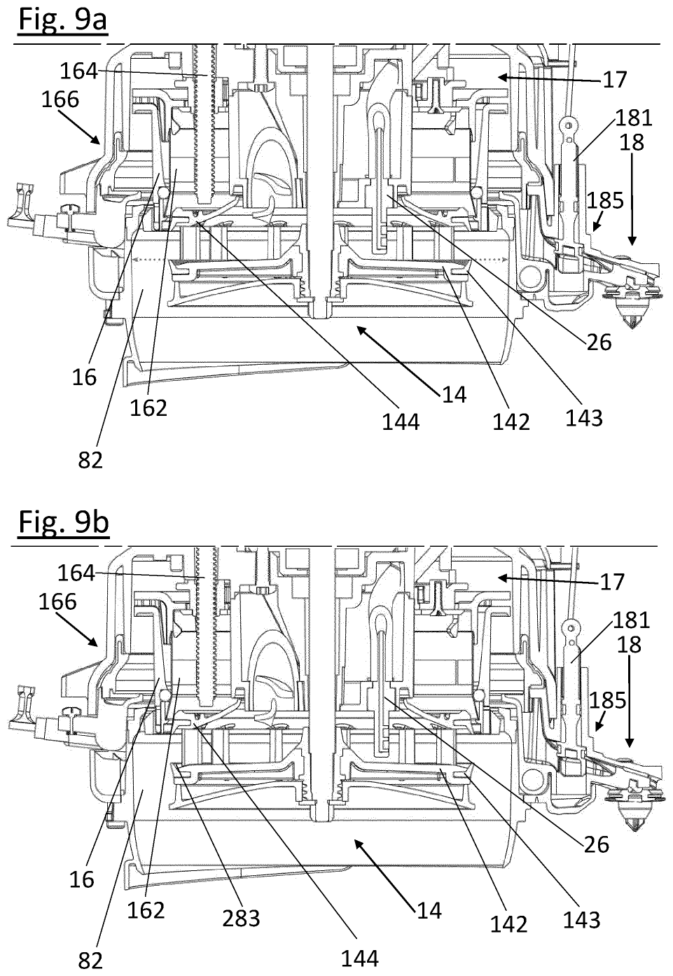

Turning to FIG. 9a, the device control system has caused the operation of the centrifugal brewing unit motor to provide a rotational speed of the centrifugal brewing unit 12. This causes the third predetermined volume of liquid 283 to be expelled towards the residue deflection cone 82. This is depicted by the dashed grey arrows. In FIG. 9b, the third predetermined volume of liquid 283 has been ejected and the residue deflection cone 82 has been evenly wettened. The sequence that is executed in FIGS. 8b, 9a, and 9b may be repeated several times.

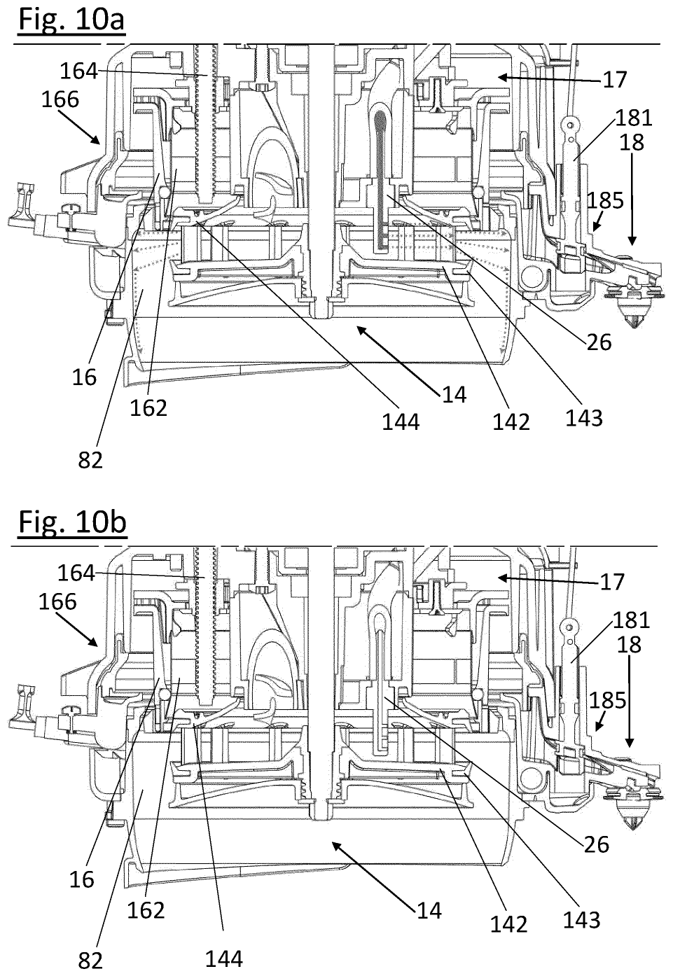

Turning to FIG. 10a, the liquid supply assembly is operated for the direct water injection nozzle 26 to spray the liquid directly onto the residue deflection cone while the centrifugal brewing unit rotates.

The sequence depicted in FIGS. 8a, 8b, 9a, 9b, and 10a leads to the situation in FIG. 10b. Here, the residue deflection cone has been cleaned and the injected liquid has been collected in a residue tray (not depicted) located below the chamber element 14.

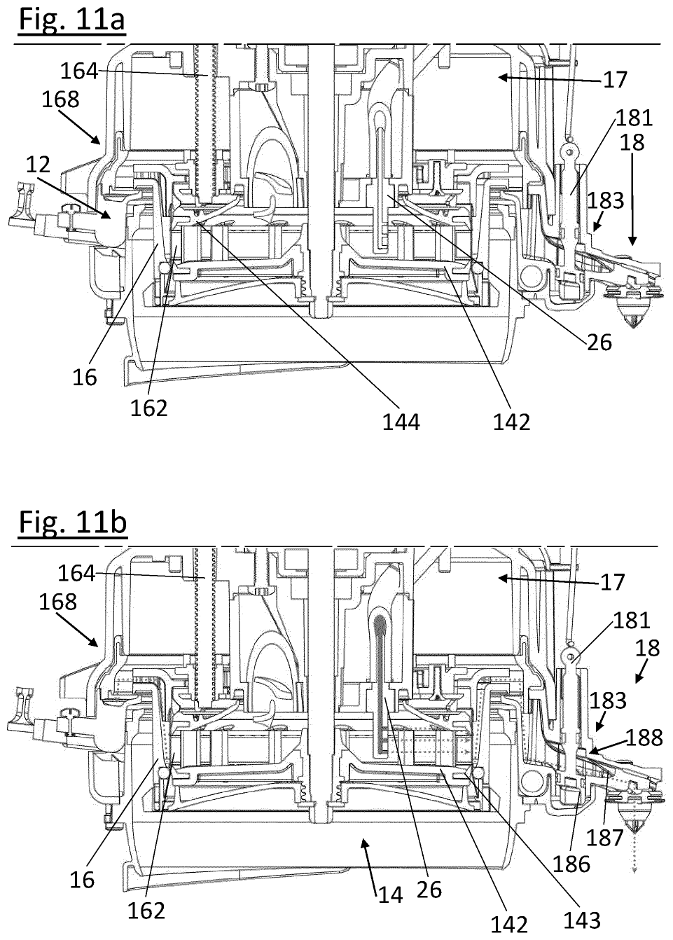

In FIG. 11a, the centrifugal coffee brewing device 10 is depicted with the cylinder element 16 in the lower position 168 and with the spout 18 in the dispensing state 183. Herein, the spout exit hole 188 has been brought in line with the spout exit channel 187 and the gutter 80 to enable the liquid to flow out through the spout. Turning to FIG. 11b, the centrifugal brewing unit 12 is rotating and the liquid supply assembly 242 injects liquid into the chamber element 14. The centrifugal force caused by the rotating chamber element 14 causes the injected liquid to flow through the filter 162 and the cylinder element 16 into the gutter 80 and to exit the centrifugal coffee brewing device via the spout 18. Herein, the spout 18 may be moved into the dispensing state 183 prior to or after the ejecting of the volume of liquid. Such a sequence may be used to pre-heat the flow path of the coffee that is to be brewed by using a hot liquid.

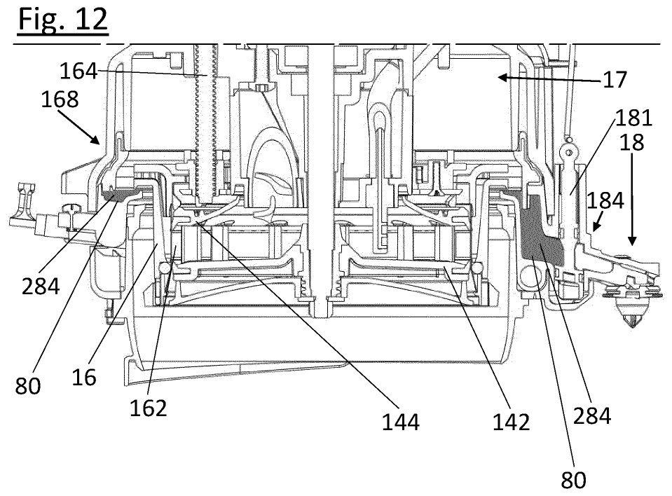

In FIG. 12, the situation is depicted wherein the liquid is ejected before the spout 18 has been moved into the dispensing state 183. Here, the spout 18 is in the closed state 184. This causes the ejected liquid to accumulate in the gutter 80. In particular, the liquid supply assembly 242 has injected a fourth predetermined volume of liquid 284 that to substantially fill the gutter 80. The liquid may be a descaling liquid in order to remove scale that has built up in the gutter 80. After having remained in the gutter 80 for an amount of time, in particular less than 10 minutes, more in particular less than 5 minutes, the spout 18 is moved into the dispensing state and the liquid exits the centrifugal coffee brewing device through the spout 18.

It will be understood that the device control system 20 can be configured to repeat the selection and execution of at least one of the cylinder element actuator control signal, centrifugal brewing unit motor control signal, liquid supply assembly control signal, spout actuator control in any possible order. In this way the above sequences may be combined to arrive at even better cleaning sequences.

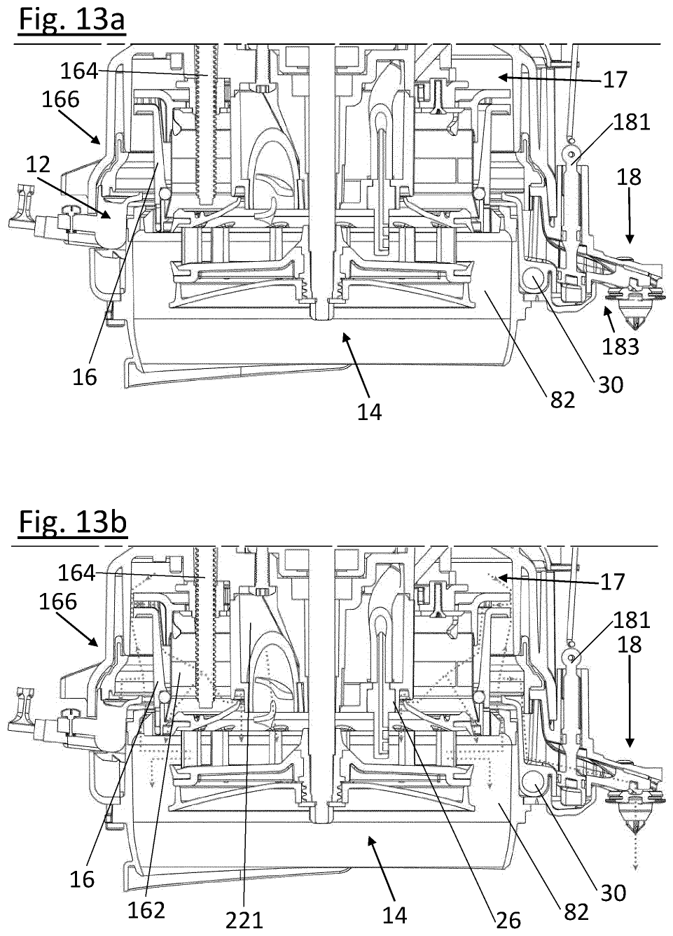

Moving to FIG. 13a, the centrifugal coffee brewing device 10 is shown in a configuration just after brewed coffee or after one of the cleaning sequences previously described. Here, the cylinder element 16 is located in the upper position 166 and the spout 18 is in the dispensing state 183.

The device control system 20 has been configured to select and execute a predetermined sequence of the at least one heater element control signal 207 and the at least one motor control signal 206. This selection and execution of the predetermined sequence causes the heater element 30 to heat at least the residue deflection cone 82 and causes at least the chamber element 14 to rotate at a specific speed and in a specific direction. During this rotation, the centrifugal brewing unit 12 is substantially free of unbrewed ground coffee and the liquid supply assembly 242 does not supply a liquid into the chamber element 14 during the predetermined sequence.

The selection and execution of the predetermined sequence causes the centrifugal coffee brewing device 10 to operate the heater element 30 to heat at least the residue deflection cone 82 and to operate the centrifugal brewing unit motor 121 to provide a rotational speed of the centrifugal brewing unit 12. In doing so, at least part of the air located inside the centrifugal coffee brewing device 10 is heated; this increases the drying of the device. Further, the rotation of the centrifugal brewing unit 12 causes the heated air to circulate through the centrifugal coffee brewing device.

In FIG. 13b, the cylinder element 16 has been moved upwards to the upper position 166 prior to or during the operation of the centrifugal brewing unit motor 121. The dotted grey arrows depict the airflow resulting from the rotation of the centrifugal brewing unit motor. A portion of the air is drawn in through the supply tube 221 functioning as an air inlet and into the chamber element 14. From here the air circulates through the device and is ultimately expelled through the spout 18 and blows past the residue deflection cone 82. The latter function as air outlets. This sequence may dry both the inner workings of the centrifugal coffee brewing device and residue that is located in a residue tray below the chamber element 14.

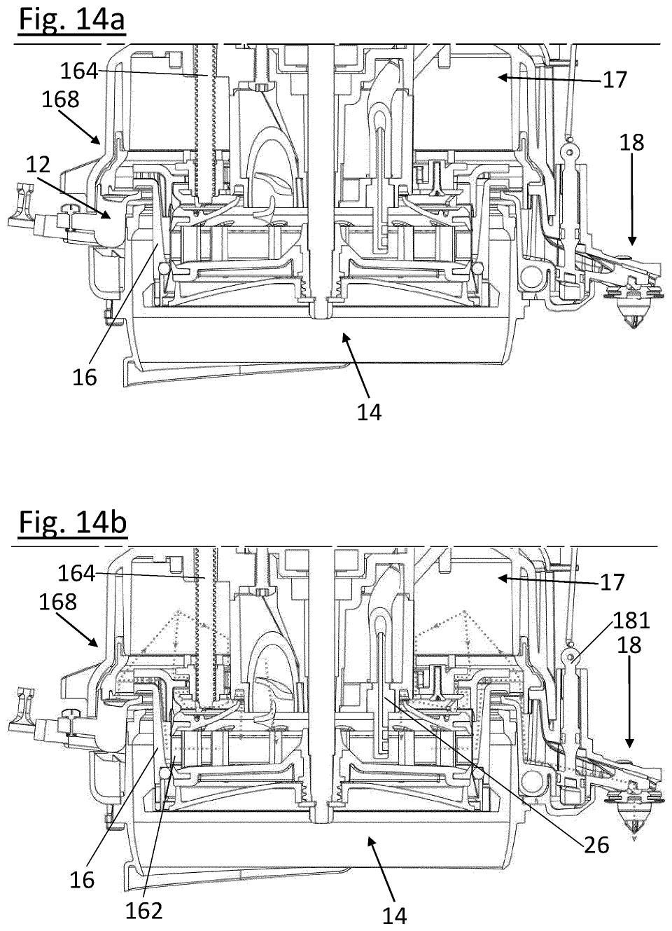

In FIG. 14a, the selection and execution of a cylinder element actuator control signal 204 has caused the cylinder element actuator 164 to move the cylinder element 16 into the lower position 168 prior to or during the operation of the centrifugal brewing unit motor.

Turning to FIG. 14b, the rotation of the centrifugal brewing unit 12 sucks in air through the supply tube and the cylinder element cavity 17. Subsequently, because the cylinder element 16 is in place, the air flow indicated by the grey dotted arrows is forced through the filter 162 and the gutter and exits through the spout 18. In doing so, the inner workings of the centrifugal coffee brewing device are dried.

The choice of the location of the cylinder element determines how the air flows within the centrifugal coffee brewing device. In any case, various openings may function as air outlets and various openings may function as air inlets

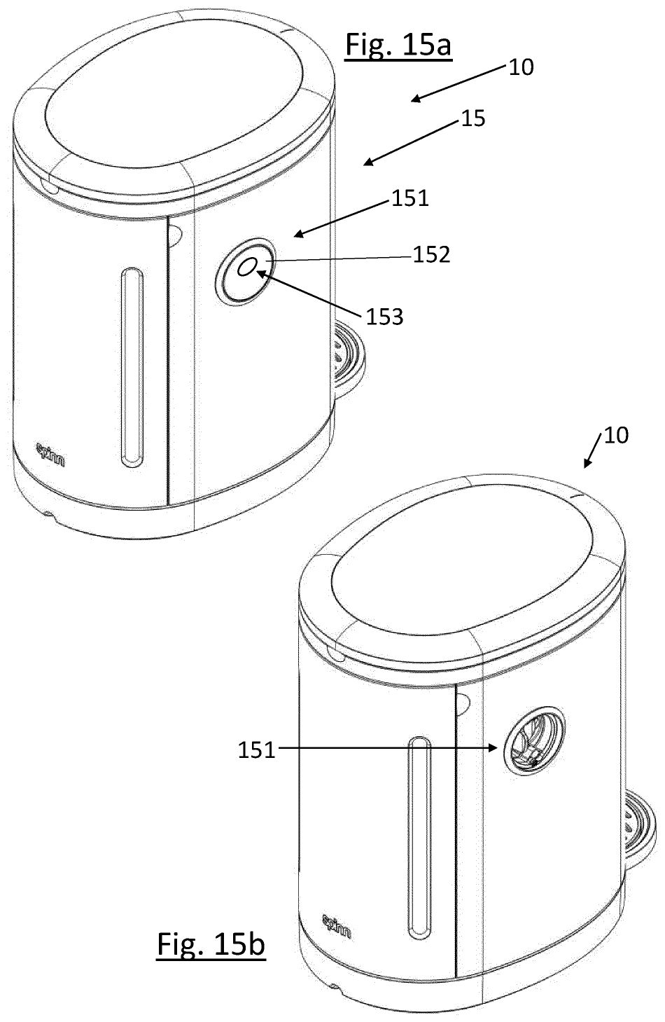

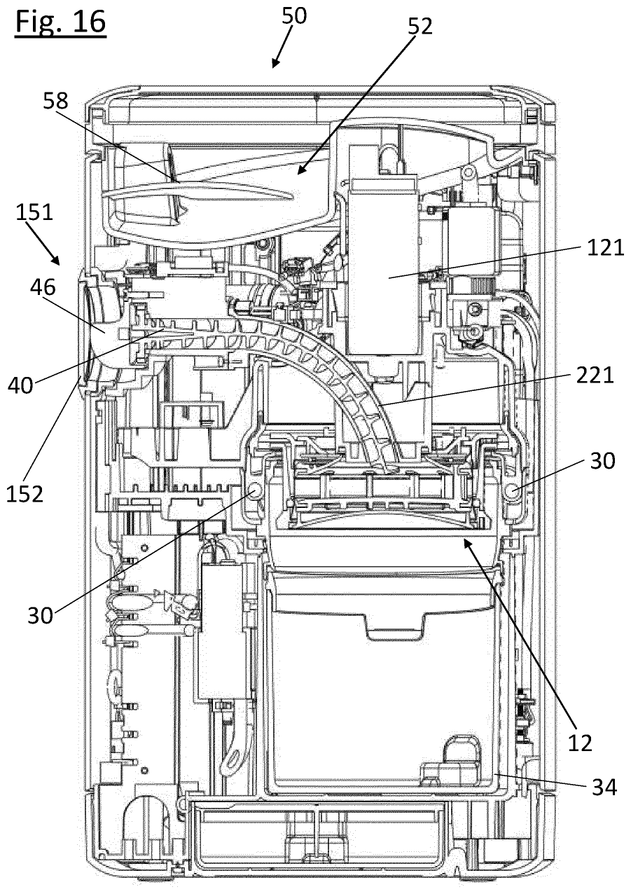

Turning to FIGS. 15a, 15b, and 16 an embodiment of the centrifugal coffee brewing device 10 is shown. Herein, the centrifugal coffee brewing device comprises a housing 15 that defines a hole 151, a centrifugal brewing unit 12, and a conveyor. The conveyor comprises a supply tube 221 and a transport screw 40 that extends through the supply tube and is mounted for rotation. The transport screw 40 comprises an end that is located near the hole 151 and is removable through said hole.

The centrifugal coffee brewing device is shown to comprise a removable cover 152 for the hole; in FIGS. 15a and 16 the cover covers the hole 151 and in FIG. 16b the cover has been removed to access the transport screw.

It can be seen in FIG. 15a that the transport screw 40 is located in a curved supply tube 221. The transport screw 40 can be made of a flexible material to enable its rotation in the curved supply tube 221 or for ease of removal of the transport screw 40 through the hole 151.

In the embodiment shown in FIG. 15a, an opening 153 is defined in the cover 152. This creates an air channel between the centrifugal brewing unit and the exterior of the housing.

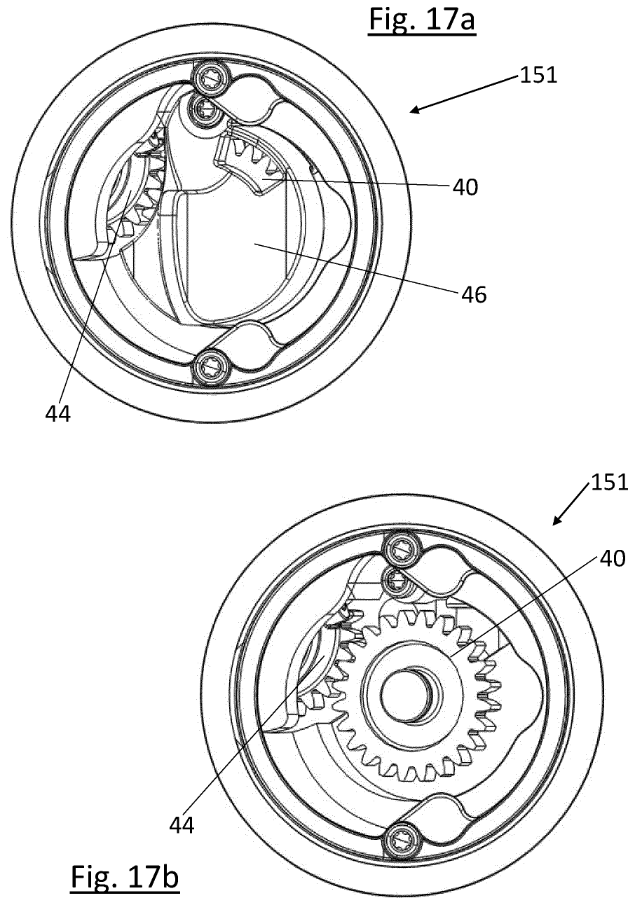

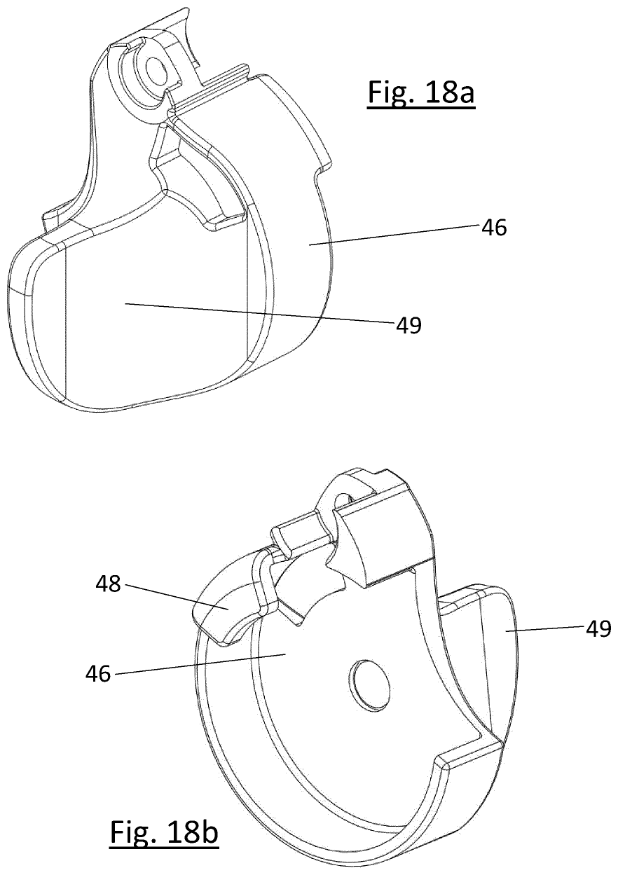

Turning to FIG. 17a the hole 151 is shown in greater detail. Herein, the centrifugal coffee brewing device further comprises a transport screw cap 46. The cap is shown in a protection position, wherein it covers part of the transport screw 40 and the transport screw drive 44. FIG. 17b shows the same as FIG. 18a only without the transport screw cap 46 in place. This means that the transport screw 40 and the transport screw drive 44 are exposed and can be dangerous for a user. The transport screw cap mainly functions as a protection.

FIGS. 18a and 18b shows the transport screw cap 46 standing alone. FIG. 18a shows the side of the transport screw cap 46 that faces away from the transport screw 40 in the protection position. The transport screw cap comprises a removal tab 49 that is configured to be engaged by a user to remove the transport screw 40 from the supply tube 221. FIG. 18b shows the side of the transport screw cap 46 that faces towards the transport screw 40 in the protection position. The transport screw comprises a hook element 48 on this side. The hook element is at least partially located behind part of the transport screw 40 in the protection position. The hook element 48 is configured to engage the transport screw 40 when the transport screw cap 46 is moved away from the protection position, for example by a user pulling on the removal tab 49.

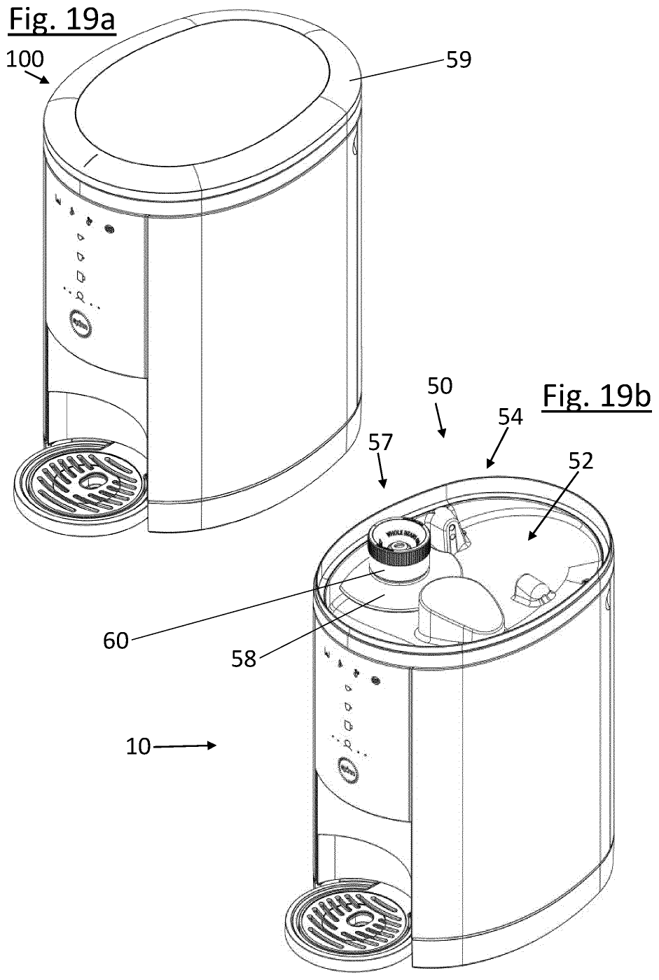

Turning to FIGS. 19a and 19b, a coffee brewing device 100 is shown with and without a hopper cover 59. In FIG. 19b, where the hopper cover 59 has been removed, a hopper 50 comprises a hopper filling opening 54 and defines an inner volume 52. Within the hopper a chute 60 is located in a chute position 57.

In the depicted embodiment, the chute 60 extends through a protection cover 58 that is located in the inner volume 52 of the hopper. Such a protection cover 58 is located above a grinder to keep users from accessing the grinder.

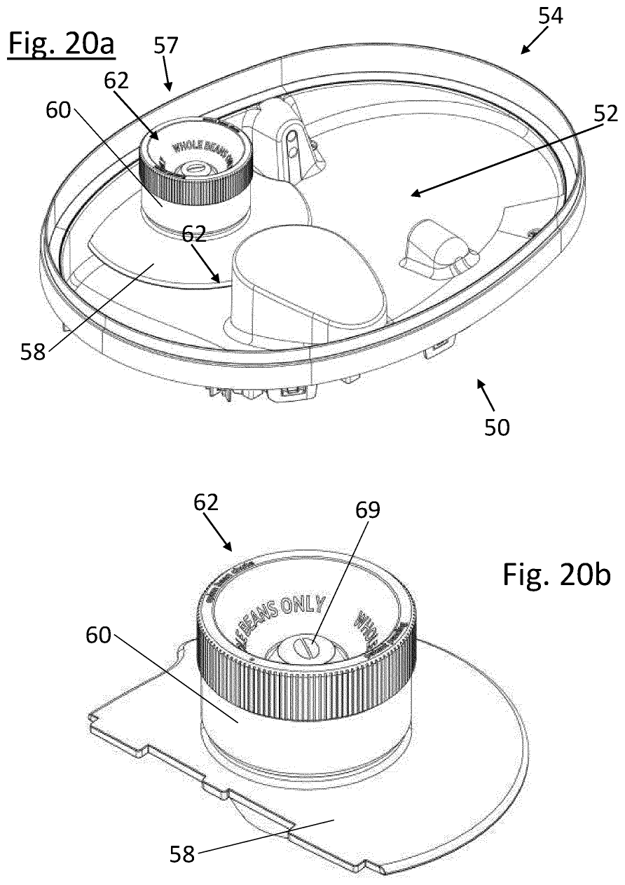

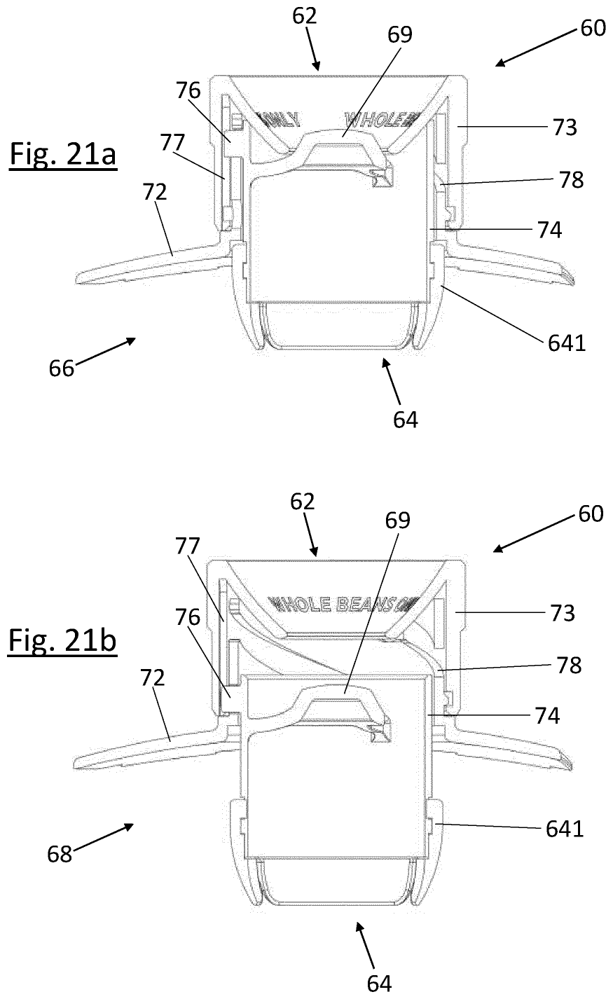

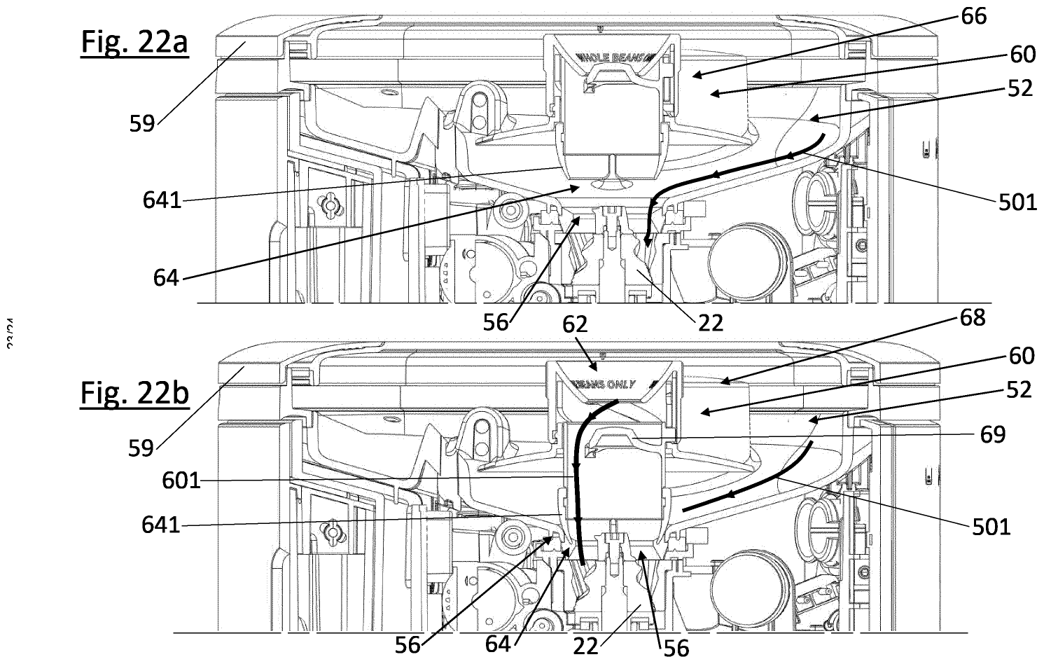

FIG. 20a shows the hopper 50 and the chute as described above. In both FIGS. 20a and 20b, a chute filling opening 62 is shown. Through this opening, coffee beans can be fed to the chute 60. An obstruction 69 is present between the chute filling opening 62 and a chute exit opening 64 (depicted in FIGS. 21a and 21b). The obstruction is configured to allow beans to move between the chute filling opening to the chute exit opening and to prevent a user to reach the chute exit opening when the chute is located in the chute position.

In FIGS. 21a and 21b, cross-sections of a chute are shown, wherein the chute is in a retracted state 66 and in an extended state 68. The depicted chute comprises a chute filling opening 62 at one end and a chute exit opening 64 at a second end. The chute 60 comprises a telescopic mechanism to move between the retraced state 66 and the extended state 68. Herein, a fixed part 72 is fixed with respect to the coffee brewing device when the chute is located in the chute position.

The chute 60 further comprises a first rotational part 73 and a second rotational part 74, the first rotational part being rotatable by a user. The fixed part 72 comprises a helical cam track 78 and the second rotational part 74 comprises a cam 76. The rotation of the first rotational part moves the cam over the helical cam track. Herein the cam movement moves the second rotational part comprising the chute exit opening 64 between the retracted state 66 and the extended state 68.

The rotation of the first rotational part 73 moves the cam 76 over the helical cam track 78, because the cam protrudes through the hole defined by the helical cam track into a vertically oriented slot 77 in the first rotational part. When rotating the first rotational part 73, the vertically oriented slot 77 exerts a horizontal force on the cam 76. The cam in turn moves over the helical cam track 78 and because the helical cam track is partially vertically oriented, the cam 76 also moves vertically in the vertically oriented slot 77 of the first rotational part 73.

In FIGS. 22a and 22b, the chute 60 is shown respectively in the retracted state 66 and in the extended state 68. In FIG. 22a, the hopper cover 59 is in place and a first bean supply path 501 is shown that extends between the inner volume 52 and the grinder 22. The first bean supply path 501 passes below the chute exit opening 64 and through the hopper exit opening 56. In FIG. 22b, the chute 60 has been extended into the extended state 68 and a flexible skirt 641 of the chute located at the chute exit opening 64 is shown engaging the hopper exit opening 56. A second bean supply path 601 is shown extending between the chute filling opening 62 and the grinder 22. The second bean supply path passes through the chute exit opening 64 and through the hopper exit opening 56. The chute 60 is shown to obstruct the first bean supply path 501. Further, an obstruction 69 is depicted, wherein the obstruction limits the direct access from the chute filling opening 62 to the chute exit opening 62.

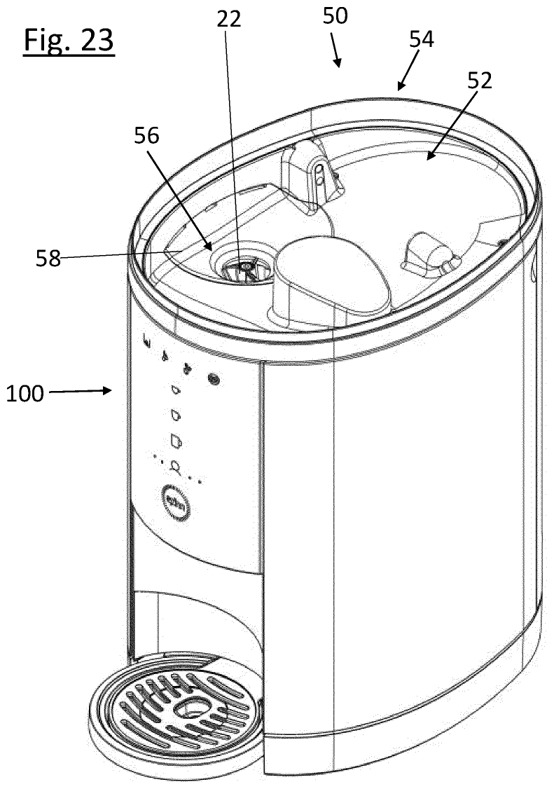

FIG. 23 shows an embodiment of the coffee brewing device 100. to illustrate the purpose of the protection cover 58, through which the chute 60 may extend, the protection cover 58 is depicted see-through and without the chute 60. Without the protection cover 58, a user can freely access the hopper exit opening 56 and the grinder 22; this would not be safe.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising i.e., open language, not excluding other elements or steps.

Any reference signs in the claims should not be construed as limiting the scope of the claims or the invention. It will be recognized that a specific embodiment as claimed may not achieve all of the stated objects.

The mere fact that certain measures are recited in mutually different dependent claims does not indicate that a combination of these measures cannot be used to advantage.

White lines between text paragraphs in the text above indicate that the technical features presented in the paragraph may be considered independent from technical features discussed in a preceding paragraph or in a subsequent paragraph.

1. A centrifugal coffee brewing device, the centrifugal coffee brewing device comprising:
a centrifugal brewing unit constructed to brew coffee, the centrifugal brewing unit comprising:
a chamber element comprising a bottom wall, a rotational roof portion and a stationary roof portion,
a cylinder element comprising a filter,
a grinder constructed to grind coffee beans,
a supply tube extending between the grinder and the centrifugal brewing unit,
a cylinder element actuator, configured to move the cylinder element upwards and/or downwards, the cylinder element actuator being controllable by at least one cylinder element actuator control signal,
a centrifugal brewing unit motor configured to rotate at least the chamber element of the centrifugal brewing unit around a first axis, the centrifugal brewing unit motor being controllable by at least one motor control signal,
a liquid supply assembly comprising a liquid inlet channel configured to supply liquid into the chamber element, wherein the liquid comprises water and/or a cleaning agent, the liquid supply assembly being controllable by at least one liquid supply assembly control signal,
a device control system configured for providing:
at least one cylinder element actuator control signal to the cylinder element actuator to control the cylinder element actuator to provide an upwards and/or downwards movement of the cylinder element,
at least one motor control signal to the centrifugal brewing unit motor to control the centrifugal brewing unit motor to provide a specific rotational speed of at least the chamber element, and a specific rotation direction of at least the chamber element, and
the at least one liquid supply assembly control signal to the liquid supply assembly to control the liquid supply assembly to provide at least a specific volume of liquid,
wherein the device control system is configured to select and execute a predetermined sequence of the at least one cylinder element actuator control signal, the at least one motor control signal to the centrifugal brewing unit motor, and the at least one liquid supply assembly control signal to the liquid supply assembly, wherein the selection and execution of the predetermined sequence causes the cylinder element to move upwards and/or downwards, causes at least the chamber element to rotate at a specific speed and in a specific direction, and causes the liquid supply assembly to provide a specific volume of liquid, to clean the centrifugal coffee brewing device,
wherein the centrifugal brewing unit is substantially free of unbrewed ground coffee during the predetermined sequence.

2. The centrifugal coffee brewing device according to claim 1, wherein the device control system is configured to drive the centrifugal brewing unit motor and the liquid supply assembly to vary over time at least one of:
the rate of flow of liquid,
the volume of liquid,
the rotational speed of at least the chamber element.

3. The centrifugal coffee brewing device according to claim 1, wherein the device control system is configured to select and execute a combination of the cylinder element control signal, the motor control signal, and the liquid supply assembly control signal, to cause the centrifugal coffee brewing device to:
a) operate the cylinder element actuator to move the cylinder element to a lower position,
b) successively operate the liquid supply assembly to provide a predetermined volume of liquid to the centrifugal brewing unit,
c) successively or simultaneously operate the centrifugal brewing unit motor to provide a rotational speed of the centrifugal brewing unit, wherein the rotational speed is varied over time.

4. The centrifugal coffee brewing device according to claim 3, wherein the device control system is configured to select and execute a motor control signal that causes the centrifugal brewing unit to eject the volume of liquid less than a minute before using the device to brew coffee, in particular the selection and execution of the motor control signal causing the flushing and pre-heating the flow path of the coffee.

5. The centrifugal coffee brewing device according to claim 1, wherein the device control system is configured to select and execute a motor control signal that causes the centrifugal brewing unit to accelerate and decelerate one or more times before ejecting the volume of liquid.

6. The centrifugal coffee brewing device according to claim 5, wherein the device control system is configured to select and execute a motor control signal that causes a first predetermined volume of liquid to clean the chamber element and a first side of the filter and a second side of the filter, the first side facing towards the chamber element, and the second side facing away from the chamber element.

7. The centrifugal coffee brewing device according to claim 1, wherein the supply tube extends into the chamber element.

8. The centrifugal coffee brewing device according to claim 1, wherein the predetermined amount volume of liquid is at least one third of an inner volume of the centrifugal brewing unit.

9. The centrifugal coffee brewing device according to claim 1, wherein the device control system is configured to select and execute a motor control signal that causes the operation of the centrifugal brewing unit motor a predetermined amount of time after the device control system causes the operation of the liquid supply assembly.

10. The centrifugal coffee brewing device according to claim 1, further comprising a cylinder element cavity configured to accommodate the cylinder element in an upper position, wherein a second predetermined volume of liquid is larger than an inner volume of the centrifugal brewing unit and is smaller than the volume of the centrifugal brewing unit and the cylinder element cavity together.

11. The centrifugal coffee brewing device according to claim 10, wherein the device control system is configured to select and execute a motor control signal that causes the predetermined volume of liquid to flow back and forth through the cylinder element, in particular the flow path extending between a lower side of the roof portion and an upper side of the roof portion and through the cylinder element, wherein the flow cleans at least the upper side of the roof portion and at least a side of the cylinder element directly facing the first axis and the upper side of the roof portion.

12. The centrifugal coffee brewing device according to claim 1, further comprising a spout and a spout actuator configured to move the spout between at least a dispensing state and a closed state, the spout actuator being controllable by at least one spout actuator control signal to control the spout actuator to provide a movement between at least the dispensing state and the closed state, wherein the device control system is further configured to select and execute a spout actuator control signal to cause the operation of the spout actuator to move the spout to the closed state at least prior to the operation of the liquid supply assembly and to select and execute a spout actuator control signal to cause the operation of the spout actuator to move the spout to the dispensing state prior to or after the ejecting of the volume of liquid.

13. The centrifugal coffee brewing device according to claim 12, further comprising a coffee gutter extending around the centrifugal brewing unit and towards the spout, wherein the device control system is configured to select and execute a spout actuator control signal to move the spout to the dispensing state after the at least part of the ejected volume of liquid is in the gutter.

14. The centrifugal coffee brewing device according to claim 1, wherein the liquid supply assembly further comprises a direct water injection nozzle which extends into a brewing chamber, and wherein the device control system is configured to select and execute a combination of the cylinder element control signal, the motor control signal, and the liquid supply assembly control signal, to cause the centrifugal coffee brewing device to successively:
a) operate the cylinder element actuator to move the cylinder element to an upper position,
b) operate the liquid supply assembly to provide a third predetermined volume of liquid to the centrifugal brewing unit,
c) operate the centrifugal brewing unit motor to provide a rotational speed of at least the chamber element, wherein the rotational speed is varied over time.
d) alternate the operations of b) and c) a predetermined number of times,
e) operate the liquid supply assembly to provide a predetermined rate of flow of liquid through the direct water injection nozzle.

15. (canceled)

16. The centrifugal coffee brewing device according to claim 1, wherein the device control system is configured to repeat the selection and execution of at least one of the cylinder element actuator control signal, centrifugal brewing unit motor control signal, liquid supply assembly control signal, spout actuator control, and wherein the device control system is configured to select and execute the predetermined sequence an amount of time after the centrifugal coffee brewing device has been used to brew coffee, in particular after 1-15 minutes, more in particular after 5-10 minutes, even more in particular after 7 minutes.

17.-40. (canceled)
